(19) United States
(12) Patent Application Publication
(10) Pub. No.: US 2020/0079670 A1
(43) Pub. Date: Mar. 12, 2020

(54) COADMINISTRATION OF SULFIDE OXIDIZING BACTERIA AND NITRATES FOR MANAGEMENT AND CONTROL OF HYDROGEN SULFIDE PRODUCTION IN WASTEWATER

(71) Applicants: Leigh E. Falkman, Sun City, AZ (US); Gregory S. Patterson, Hopkins, MN (US)

(72) Inventors: Leigh E. Falkman, Sun City, AZ (US); Gregory S. Patterson, Hopkins, MN (US)

(21) Appl. No.: 16/462,821

(22) PCT Filed: Dec. 1, 2017
(86) PCT No.: PCT/US2017/064130

§ 371 Date: May 21, 2019

Related U.S. Application Data
(60) Provisional application No. 62/429,322, filed on Dec. 2, 2016.

(51) Int. Cl. C02F 3/34; C02F 3/28

(52) U.S. Cl. CPC C02F 3/345; C02F 3/28; C02F 2101/101; C02F 2307/08; C02F 2303/02

(57) ABSTRACT

A cost effective and environmentally sound method of controlling hydrogen sulfide in a wastewater collection systems comprising administration of anaerobic sulfide oxidizing bacteria along with limited amounts of nitrate.

### BACKGROUND

Control of hydrogen sulfide production in wastewater, particularly sewage collection systems, has been an ongoing concern for centuries. Hydrogen sulfide is generated in wastewater when sulfate-reducing bacteria growing in the biofilm layer of wastewater consumes sulfate oxygen found in the wastewater, releasing bisulfide ions (SH⁻). The bisulfide ions combine with hydrogen to form hydrogen sulfide (H₂S) which is released into the surrounding atmosphere as a malodorous gas. Released hydrogen sulfide gas is subsequently consumed by aerobic sulfate-oxidizing bacteria, such as Thiobacillus, growing on the moist surfaces of the various components of the wastewater collection system, converting the hydrogen sulfide to highly corrosive sulfuric acid (H₂SO₄). Sulfuric acid mediated corrosion of the concrete conduits and steel pipes in which organic sewage is transported costs municipalities billions of dollars annually in sewage system failure and repairs.

A time tested method for achieving hydrogen sulfide control in wastewater collection systems is the application of nitrates, such as calcium nitrate (Ca(NO₃)₂), to the wastewater. Nitrates are capable of both chemically reacting with existing hydrogen sulfide to form sulfate ions (SO₄²⁻) with the release of nitrogen (N₂) and water (H₂O), and reducing aerobic reduction of sulfate ions to hydrogen sulfide by providing nitrates as an alternative preferential source of oxygen for consumption by the bacteria growing in the biofilm layer of the wastewater.

While generally effective for suppressing hydrogen sulfide generation in wastewater collection systems, nitrate treatment is ephemeral and has several significant drawbacks for long-term hydrogen sulfide control including prohibitive capital and material costs for effecting prolonged treatment and increased nitrogen and nitrate levels in the wastewater over time.

Accordingly, a substantial need exists for a cost effective and environmentally sound technique for achieving long-term control of hydrogen sulfide production in wastewater.

### DETAILED DESCRIPTION OF A PREFERRED EMBODIMENT

I have surprisingly discovered that cost effective and environmentally sound hydrogen sulfide control in a wastewater collection systems can be achieved by the limited administration of nitrate with the coadministrating of anaerobic sulfide oxidizing bacteria. Without intending to be limited thereby, I believe that administration of anaerobic sulfide oxidizing bacteria reduces hydrogen sulfide by oxidizing hydrogen sulfide to sulfate as well as the intracellular sequestration of sulfur. This, when accompanied by an increase in the bioavailability of nitrate oxygen for use by the bacteria in the biofilm, results in excellent suppression of hydrogen sulfide production with reduced nitrate loading.

Nitrates, such as calcium nitrate, used in concert with anaerobic sulfide oxidizing bacteria provide for a more complete reduction of hydrogen sulfide gas by providing multiple modes of action for its reduction. Through the synergistic treatment methodology of the present invention, using a nitrate to biologically change the biogenic populations and reducing agents in the sewage biofilm and adding anaerobic sulfide oxidizing bacteria to oxidize any residual hydrogen sulfide that is formed from the biofilm, more complete control of hydrogen sulfide gas is achieved. The synergistic effect of employing these two additives allows less of each additive to be employed relative to the amount necessary when used alone, making the technique a more cost effective and environmentally sound solution. The process also provides for a denitrification pathway through the sulfur oxidizing bacteria to scavenge any residual nitrates that are added in the system, thus reducing the nitrogen load on the waste treatment plant. The nitrate is preferably added as an aqueous solution of an alkali or alkaline earth metal nitrate, such as a 50% active aqueous solution of a calcium and/or sodium nitrate.

An alkali metal may also be coadministered for purposes of neutralizing the pH of the wastewater. The preferred alkali metal is Mg(OH)₂. It is generally desired to add sufficient alkali metal to adjust the pH of the wastewater to between 6 and 9 with a preference for a pH of between 7 and 9.

Any genus and species of anaerobic sulfide oxidizing bacteria may be employed, with selection generally guided by the particular conditions (e.g., dissolved oxygen concentration, pH, temperature, etc.) of the wastewater being treated. The anaerobic sulfide oxidizing bacteria is preferably employed as a bacterial consortium.

A listing of preferred bacteria species for inclusion in the bacterial consortium is provided below in Table One.

TABLE ONE
Bacterial Consortium

| Purple | Purple | Green | Filamentous | Colorless |
|---|---|---|---|---|
| Bacteria | Non-Sulfur | Sulfur | Green | Sulfur |
| Chromatium | Bacteria | Bacteria | Bacteria | Bacteria |
| Chromatium | Rhodspirrillum | Chlorobium | Chloroflexus | Beggiatoaceae |
| Thiocyctis | Rhodobacter | Prosthecochloris | Chloronema | Achromatium |
| Thiospirillum | Rhodopseudomonas | Pelodictyon | Oscillochloris | Thiobacterium |
| Thiocapsa | Rhodomicrobium | Ancalochloris | | Macromonma |
| Lamprocystis | Rhodopila | Chloroherpeton | | Thiospira |
| Lamprobacter | | | | Thiovulum |
| Thiopedia | | | | Bilophocucus |
| | | | | Thiobacillus |
| | | | | Thiomicrospira |
| | | | | Thiodendron |
| | | | | Thiosphaera |
| | | | | Acidiphilium |
| | | | | Thermothrix |
| | | | | Sulfolobus |
| | | | | Acidianus |

The consortium can include at least 1 to 10 parts by CFU purple bacteria, at least 1 to 10 parts by CFU purple non-sulfur bacteria, at least 1 to 10 parts by CFU green sulfur bacteria, at least 1 to 10 parts by CFU filamentous green bacteria, and at least 1 to 10 parts by CFU colorless sulfur bacteria.

The consortium can further include at least two different species of purple bacteria, at least two different species of purple non-sulfur bacteria, at least two different species of green sulfur bacteria, at least two different species of filamentous green bacteria, and at least two different species of colorless sulfur bacteria.

Coadministration of the nitrate and the anaerobic sulfide oxidizing bacteria may be effected in any sequence and on substantially any schedule, with a preference for commencement of nitrate administration coincidentally with or up to two weeks prior to commencement of administration of the anaerobic sulfide oxidizing bacteria, followed by coincidental administration thereafter.

Effective relative loadings of nitrate and the anaerobic sulfide oxidizing bacteria, per 100,000 gallons of wastewater, are noted in Table Two.

TABLE TWO
Loading

| | Curative | Maintenance |
|---|---|---|
| Additive | Dosing | Dosing |
| Nitrate (liquid form @ | 10-100 ounces/lb | 1-50 ounces/lb |
| 100-450K ppm) | of H₂S | of H₂S |
| Sulfide oxidizing bacteria | 1-10 gallons | 12 ounces-10 gallons |
| (1 billion CFU's) | | |

Generally, effective results can be achieved by inoculating the wastewater with 10³ to 10⁸ CFUs of anaerobic sulfide oxidizing bacteria per 100,000 gallons of wastewater with coadministration of between 10% and 500% of a stoichiometric amount of NO₃ relative to H₂S in the wastewater, with a general preference for inoculating the wastewater with 10⁴ to 10⁸ CFUs of anaerobic sulfide oxidizing bacteria per 100,000 gallons of wastewater with coadministration of between 20% and 500% of a stoichiometric amount of NO₃ relative to H₂S in the wastewater.

More many applications, excellent cost effective results can be achieved by inoculating the wastewater with 10⁴ to 10⁸ CFUs of anaerobic sulfide oxidizing bacteria per 100,000 gallons of wastewater with coadministration of between 50% and 300% of a stoichiometric amount of NO₃ relative to H₂S in the wastewater.

Administration may be made on substantially any schedule, with a preference for regularly schedule administration on a daily or weekly basis, with relatively continuous administration most preferred when automated administrations is an option.

I claim:

1. A method of reducing sulfide malodor in wastewater collection and treatment systems comprising coadministration of a nitrate and anaerobic sulfide oxidizing bacteria to wastewater in amounts sufficient to reduce hydrogen sulfide levels.

2. The method of claim 1 including the step of administering an alkali salt to the wastewater in combination with the nitrate and anaerobic sulfide oxidizing bacteria in an amount sufficient to adjust the pH of the wastewater to a pH of 6-9.

3. The method of claim 1 wherein the wastewater is sewage.

4. The method of claim 1 wherein the nitrate is an alkali or alkaline earth metal nitrate.

5. The method of claim 4 wherein the nitrate is a calcium nitrate or sodium nitrate.

6. The method of claim 1 wherein the anaerobic sulfide oxidizing bacteria is a consortium of bacteria that includes at least 1 to 10 parts by CFU purple bacteria, at least 1 to 10 parts by CFU purple non-sulfur bacteria, at least 1 to 10 parts by CFU green sulfur bacteria, at least 1 to 10 parts by CFU filamentous green bacteria, and at least 1 to 10 parts by CFU colorless sulfur bacteria.

7. The method of claim 6 wherein the consortium of bacteria includes at least two different species of purple bacteria, at least two different species of purple non-sulfur bacteria, at least two different species of green sulfur bacteria, at least two different species of filamentous green bacteria, and at least two different species of colorless sulfur bacteria.

8. The method of claim 1 wherein the wastewater is inoculated with 10³ to 10⁸ CFUs of anaerobic sulfide oxidizing bacteria per 100,000 gallons of wastewater and between 10% and 500% of a stoichiometric amount of NO₃ relative to H₂S in the wastewater.

9. The method of claim 2 wherein the wastewater is inoculated with 10⁴ to 10⁸ CFUs of anaerobic sulfide oxidizing bacteria per 100,000 gallons of wastewater and between 20% and 500% of a stoichiometric amount of NO₃ relative to H₂S in the wastewater.

10. The method of claim 6 wherein the wastewater is inoculated with 10⁵ to 10⁷ CFUs of anaerobic sulfide oxidizing bacteria per 100,000 gallons of wastewater and between 50% and 300% of a stoichiometric amount of NO₃ relative to H₂S in the wastewater.

11. The method of claim 2 wherein the alkali salt is Mg(OH)₂.

12. The method of claim 1 wherein administration occurs at intervals no less than weekly.

13. The method of claim 1 wherein administration occurs at intervals no less than daily.

14. A method of reducing sulfuric acid mediated corrosion of wastewater collection and treatment systems comprising coadministration of a nitrate and anaerobic sulfide oxidizing bacteria to wastewater in amounts sufficient to reduce sulfuric acid levels within the system.

15. The method of claim 14 including the step of administering an alkali salt to the wastewater in combination with the nitrate and anaerobic sulfide oxidizing bacteria in an amount sufficient to adjust the pH of the wastewater to a pH of 6-9.

16. The method of claim 14 wherein the wastewater is sewage.

17. The method of claim 14 wherein the nitrate is an alkali or alkaline earth metal nitrate.

18. The method of claim 17 wherein the nitrate is a calcium nitrate or sodium nitrate.

19. The method of claim 14 wherein the anaerobic sulfide oxidizing bacteria is a consortium of bacteria that includes at least 1 to 10 parts by CFU purple bacteria, at least 1 to 10 parts by CFU purple non-sulfur bacteria, at least 1 to 10 parts by CFU green sulfur bacteria, at least 1 to 10 parts by CFU filamentous green bacteria, and at least 1 to 10 parts by CFU colorless sulfur bacteria.

20. The method of claim 18 wherein the consortium of bacteria includes at least two different species of purple bacteria, at least two different species of purple non-sulfur bacteria, at least two different species of green sulfur bacteria, at least two different species of filamentous green bacteria, and at least two different species of colorless sulfur bacteria.

21. The method of claim 14 wherein the wastewater is inoculated with 10³ to 10⁸ CFUs of anaerobic sulfide oxidizing bacteria per 100,000 gallons of wastewater and between 10% and 500% of a stoichiometric amount of NO₃ relative to H₂S in the wastewater.

22. The method of claim 15 wherein the wastewater is inoculated with 10⁴ to 10⁸ CFUs of anaerobic sulfide oxidizing bacteria per 100,000 gallons of wastewater and between 20% and 500% of a stoichiometric amount of NO₃ relative to H₂S in the wastewater.

23. The method of claim 18 wherein the wastewater is inoculated with 10⁵ to 10⁷ CFUs of anaerobic sulfide oxidizing bacteria per 100,000 gallons of wastewater and between 50% and 300% of a stoichiometric amount of NO₃ relative to H₂S in the wastewater.

24. The method of claim 15 wherein the alkali salt is Mg(OH)₂.

25. The method of claim 14 wherein administration occurs at intervals no less than weekly.

26. The method of claim 14 wherein administration occurs at intervals no less than daily.

27. The method of claim 14 wherein administration occurs upstream from a centralized wastewater treatment facility.

28. The method of claim 27 wherein administration occurs remotely from the centralized wastewater treatment facility.
